(19) United States
(12) Patent Application Publication
(10) Pub. No.: US 2023/0321799 A1
(43) Pub. Date: Oct. 12, 2023

(54) Anti-Slip Fastener Driver

(71) Applicant: HONG ANN TOOL INDUSTRIES CO., LTD., Taichung City (TW)

(72) Inventor: Cheng-Wei Su, Taichung City (TW)

(21) Appl. No.: 18/172,511

(22) Filed: Feb. 22, 2023

(30) Foreign Application Priority Data
Apr. 6, 2022 (CN) 202220793814.5

(51) Int. Cl. B25B 23/10; B25B 15/00

(52) U.S. Cl. CPC B25B 23/105; B25B 15/004

(57) ABSTRACT

An anti-slip fastener driver includes a body, a driving portion and a twisting portion arranged between the body and the driving portion. The driving portion has a plurality of driving recesses and a plurality of sharp corners. A cross sectional area of one end of the twisting portion adjacent to the driving portion is less than that of the other end of the twisting portion adjacent to the body. The twisting portion has a plurality of twisting surfaces formed around an outer periphery thereof in the radial direction of the rotating axis, Each twisting surface has a short side and a long side. A projection line of the short side is not parallel to that of the long side on the reference plane.

### BACKGROUND OF THE INVENTION

The present invention relates to a fastener driver and, more particularly, to an anti-slip fastener driver.

U.S. Publication No. 2021/0237236 discloses an anti-slip fastener driver that includes a shank and a driving portion formed on an end of the shank and defining a longitudinal axis. The driving portion includes an outer periphery surrounding the longitudinal axis and having a first peripheral surface. An end of the driving portion opposite to the shank includes a first end face connected to the first peripheral surface. The first end face includes a first side and a first angle located outside of the first side. The end of the driving portion opposite to the shank includes a reference plane perpendicular to the longitudinal axis. The first side is located on the reference plane. An end of the first side is adjacent to the longitudinal axis. Another end of the first side opposite to the longitudinal axis is connected to the first peripheral surface. The first angle is located between the reference plane and the shank.

However, when the above fastener driver turns the screw, the anti-slip effect is mainly achieved by using the sharp angle generated by the slanted end face of the driving portion as a support point to cause that the driving portion possible to still slip.

Thus, a need exists for an anti-slip fastener driver to mitigate and/or obviate the above disadvantages.

### SUMMARY OF THE INVENTION

An objective of the present invention is to provide an anti-slip fastener driver, which includes a body, a driving portion and a twisting portion. The driving portion defines a reference rotating axis and a reference plane perpendicular to the rotating axis. The driving portion has a top end distal to the body in an axial direction of the rotating axis. The top end is provided with a plurality of driving recesses and a plurality of sharp corners respectively adjacent to the plurality of driving recesses. The twisting portion defines a first end connected to the driving portion and a second end connected to the body. A cross sectional area of the first end is less than a cross sectional area of the second end in a radial direction of the rotating axis. The twisting portion has a polygonal cross sectional shape in the radial direction of the rotating axis. The twisting portion is provided with a plurality of twisting surfaces formed around an outer periphery thereof about the rotating axis. Each of the plurality of twisting surfaces has a short side formed at the first end and a long side formed at the second end. A projection line of one of the short sides on the reference plane is not parallel to a projection line of one of the long sides corresponding to the short side on the reference plane. Thus, the anti-slip fastener driver provides an excellent anti-slip effect by the above structure.

In an embodiment, each of the plurality of the twisting surfaces has a contour using a curved surface function.

In an embodiment, the twisting portion is provided with a plurality of twisting sides each formed between two adjacent of the plurality of twisting surfaces. A number of the plurality of twisting sides is equal to a number of the plurality of twisting surfaces. Each of the plurality of twisting sides is straight.

In another embodiment, the twisting portion is provided with a plurality of twisting sides each formed between two adjacent of the plurality of twisting surfaces. A number of the plurality of twisting sides is equal to a number of the plurality of twisting surfaces. Each of the plurality of twisting sides is curved.

In an embodiment, the projection line of one of the short sides on the reference plane and the projection line of one of the long sides corresponding to the short side on the reference plane form a twisting angle. The twisting angle is greater than 20 degrees and less than 40 degrees.

In an embodiment, the top end of the driving portion has an end surface perpendicular to the rotating axis. The plurality of driving recesses is recessed on the end surface. The plurality of sharp corners is arranged on an outer peripheral edge of the end surface in the radial direction of the rotating axis.

In an embodiment, an outer periphery of the driving portion in the radial direction of the rotating axis is provided with six first peripheral surfaces parallel to the rotating axis. The six first peripheral surfaces are planes and form a hexagon. A first width is formed between two opposite surfaces of the six first peripheral surfaces. The plurality of driving recesses includes six driving recesses respectively connected to the six first peripheral surfaces. An outer periphery of the body in the radial direction of the rotating axis is provided with six second peripheral surfaces parallel to the rotating axis. The plurality of twisting surfaces includes six twisting surfaces each having a top edge connected to the relative first peripheral surface and a bottom edge connected to the relative second peripheral surface. The six second peripheral surfaces are planes and form a hexagon. A second width is formed between two opposite surfaces of the six second peripheral surfaces. The second width is greater than 1.2 times and less than 1.5 times the first width.

In another embodiment, an outer periphery of the driving portion in the radial direction of the rotating axis is provided with six first peripheral surfaces parallel to the rotating axis. The six first peripheral surfaces are planes and form a hexagon. A first width is formed between two opposite surfaces of the six first peripheral surfaces. The plurality of driving recesses includes three driving recesses respectively connected to three non-adjacent of the six first peripheral surfaces. An outer periphery of the body in the radial direction of the rotating axis is provided with six second peripheral surfaces parallel to the rotating axis. The plurality of twisting surfaces includes six twisting surfaces each having a top edge connected to the relative first peripheral surface and a bottom edge connected to the relative second peripheral surface. The six second peripheral surfaces are planes and form a hexagon. A second width is formed between two opposite surfaces of the six second peripheral surfaces. The second width is greater than 2.5 times and less than 2.8 times the first width.

The present invention will become clearer in light of the following detailed description of illustrative embodiments of this invention described in connection with the drawings.

### BRIEF DESCRIPTION OF DRAWINGS

FIG. 1 is a perspective view of an anti-slip fastener driver of a first embodiment according to the present invention.

FIG. 2 is a partial, side elevational view of the anti-slip fastener driver of the first embodiment according to the present invention.

FIG. 3 is an end elevational view of the anti-slip fastener driver of the first embodiment according to the present invention.

FIG. 4 is a perspective view of an anti-slip fastener driver of a second embodiment according to the present invention.

FIG. 5 is a partial, side elevational view of the anti-slip fastener driver of the second embodiment according to the present invention.

FIG. 6 is an end elevational view of the anti-slip fastener driver of the second embodiment according to the present invention.

FIG. 7 is a perspective view of an anti-slip fastener driver of a third embodiment according to the present invention.

FIG. 8 is a partial, side elevational view of the anti-slip fastener driver of the third embodiment according to the present invention.

FIG. 9 is an end elevational view of the anti-slip fastener driver of the third embodiment according to the present invention.

FIG. 10 is a perspective view of an anti-slip fastener driver of a fourth embodiment according to the present invention.

FIG. 11 is a partial, side elevational view of the anti-slip fastener driver of the fourth embodiment according to the present invention.

FIG. 12 is an end elevational view of the anti-slip fastener driver of the fourth embodiment according to the present invention.

FIG. 13 is a perspective view of an anti-slip fastener driver of a fifth embodiment according to the present invention.

FIG. 14 is a partial, side elevational view of the anti-slip fastener driver of the fifth embodiment according to the present invention.

FIG. 15 is an end elevational view of the anti-slip fastener driver of the fifth embodiment according to the present invention.

### DETAILED DESCRIPTION OF THE INVENTION

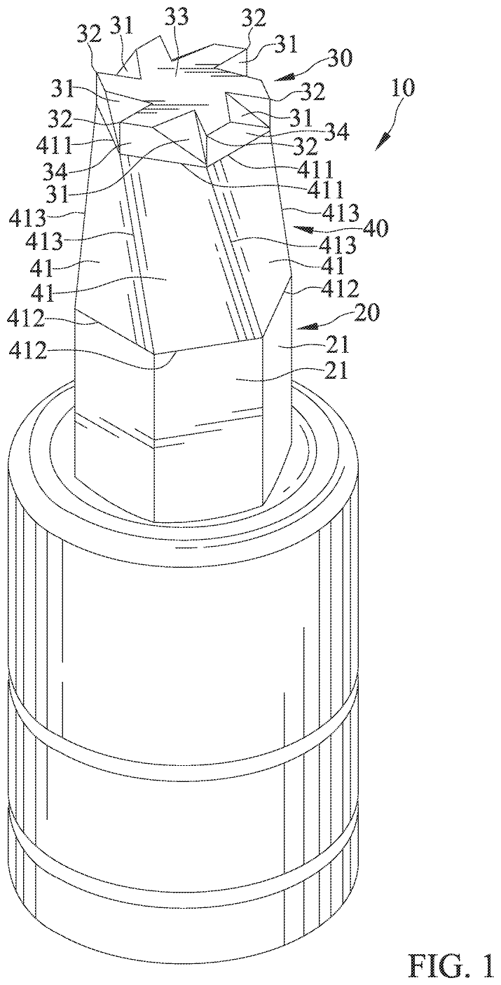

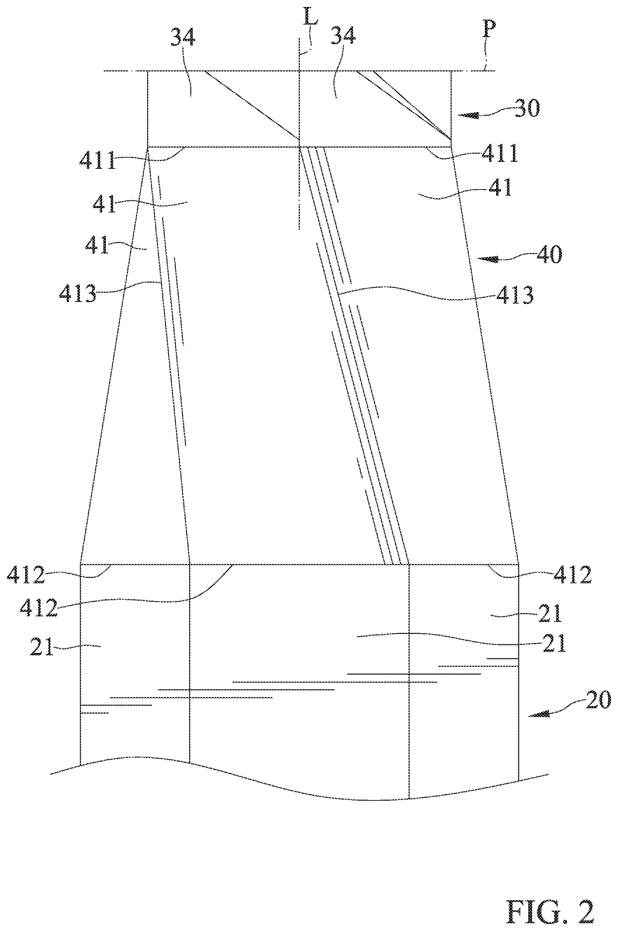

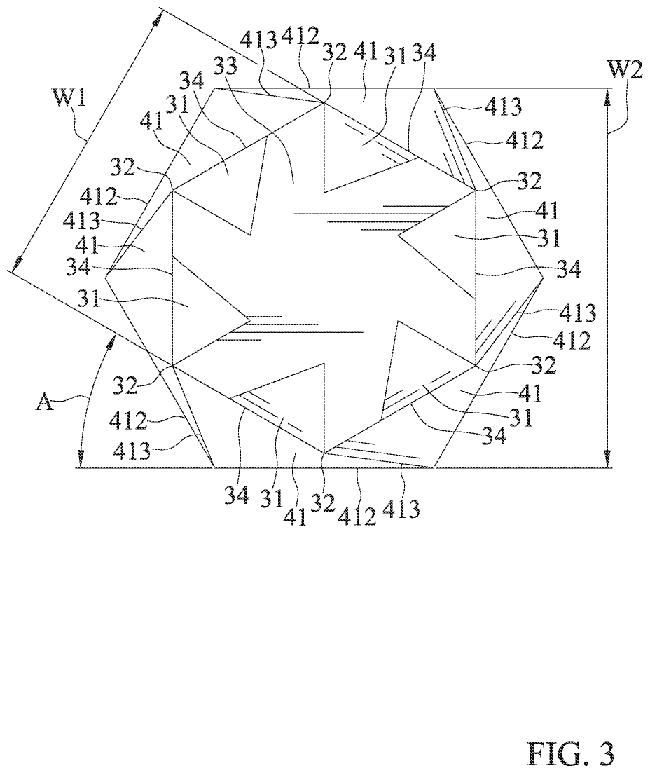

FIGS. 1-3 show a perspective view, a side elevational view, and an end elevational view of an anti-slip fastener driver 10 of a first embodiment according to the present invention. The anti-slip fastener driver 10 includes a body 20, a driving portion 30 and a twisting portion 40.

The driving portion 30 defines a reference rotating axis L and a reference plane P perpendicular to the rotating axis L. The driving portion 30;30c has a top end distal to the body 20 in an axial direction of the rotating axis L, and the top end is provided with a plurality of driving recesses 31 and a plurality of sharp corners 32 respectively adjacent to the plurality of driving recesses 31.

The twisting portion 40 defines a first end connected to the driving portion 30 and a second end connected to the body 20. A cross sectional area of the first end is less than a cross sectional area of the second end in a radial direction of the rotating axis L. The twisting portion 40 has a polygonal cross sectional shape in the radial direction of the rotating axis L. The twisting portion 40 is provided with a plurality of twisting surfaces 41 formed around an outer periphery thereof about the rotating axis L. Each of the plurality of twisting surfaces 41 has a short side 411 formed at the first end and a long side 412 formed at the second end. A projection line of one of the short sides 411 on the reference plane P is not parallel to a projection line of one of the long sides 412 corresponding to the short side 411 on the reference plane P.

In the embodiment, each of the plurality of the twisting surfaces 41 has a contour using a curved surface function.

The twisting portion 40 is provided with a plurality of twisting sides 413 each formed between two adjacent of the plurality of twisting surfaces 41. A number of the plurality of twisting sides 413 is equal to a number of the plurality of twisting surfaces 41, and each of the plurality of twisting sides 413 in the embodiment is straight.

The projection line of one of the short sides 411 on the reference plane P and the projection line of one of the long sides 412 corresponding to the short side 411 on the reference plane P form a twisting angle A, which is greater than 20 degrees and less than 40 degrees.

The top end of the driving portion 30 has an end surface 33 perpendicular to the rotating axis L. The plurality of driving recesses 31 is recessed on the end surface 33. The plurality of sharp corners 32 is arranged on an outer peripheral edge of the end surface 33 in the radial direction of the rotating axis L.

An outer periphery of the driving portion 30 in the radial direction of the rotating axis L is provided with six first peripheral surfaces 34 parallel to the rotating axis L. The six first peripheral surfaces 34 are planes and form a hexagon. A first width W1 is formed between two opposite surfaces of the six first peripheral surfaces 34. The plurality of driving recesses 31 includes six driving recesses 31 respectively connected to the six first peripheral surfaces 34. An outer periphery of the body 20 in the radial direction of the rotating axis L is provided with six second peripheral surfaces 21 parallel to the rotating axis L. The plurality of twisting surfaces 41 includes six twisting surfaces 41 each having a top edge connected to the relative first peripheral surface 34 and a bottom edge connected to the relative second peripheral surface 21. The six second peripheral surfaces 21 are planes and form a hexagon. A second width W2 is formed between two opposite surfaces of the six second peripheral surfaces 21. The second width W2 is greater than 1.2 times and less than 1.5 times the first width W1.

The anti-slip fastener driver 10 can achieve an excellent anti-slip effect by the above structure and, thus, can smoothly drive a screw even if the driving hole of the screw is damaged. In use of the anti-slip fastener driver 10, the driving portion 30 can be inserted into the damaged driving hole in a slant direction, and the plurality of sharp corners 32 are used to contact the inner wall of the driving hole of the screw to form support points, which assist to push the screw to rotate, and at the same time cooperate with the polygonal twisting structure of the twisting portion 40 to further improve the anti-slip effect.

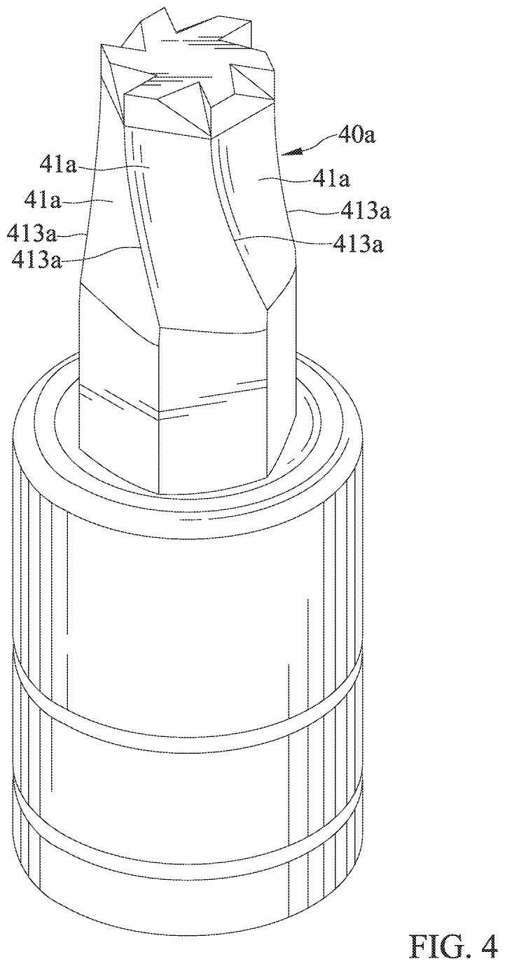

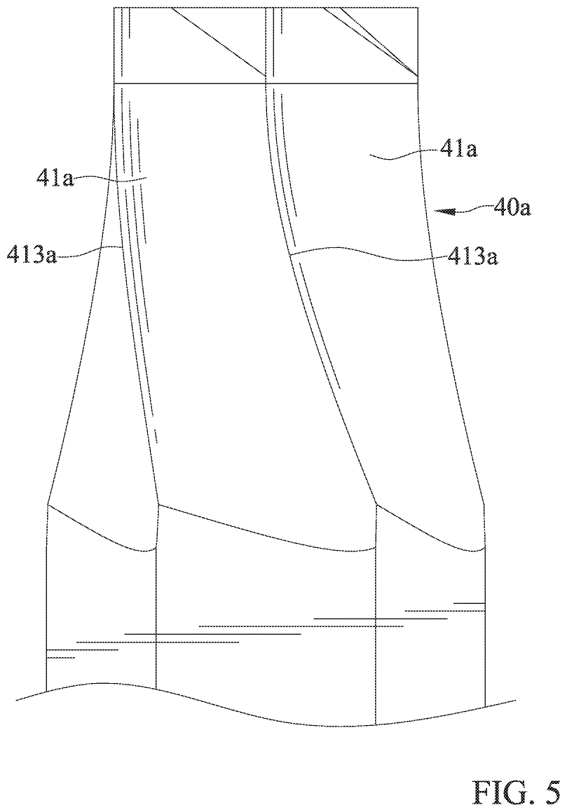

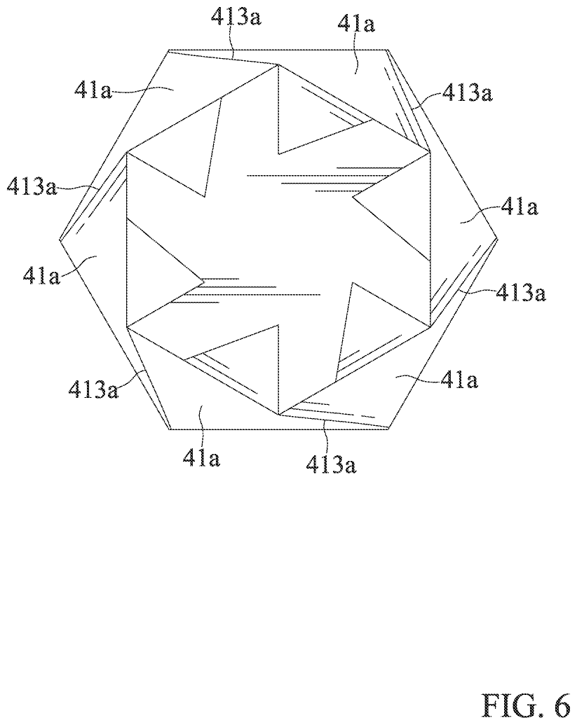

FIGS. 4-6 show a perspective view, a side elevational view, and an end elevational view of an anti-slip fastener driver of a second embodiment according to the present invention. The second embodiment is substantially the same as the first embodiment but is mainly different from the first embodiment by that each of the plurality of the twisting surfaces 41a has a contour using another curved surface function different than that of the first embodiment.

The twisting portion 40a is provided with a plurality of twisting sides 413a each formed between two adjacent of the plurality of twisting surfaces 41a. A number of the plurality of twisting sides 413a is equal to a number of the plurality of twisting surfaces 41a, and each of the plurality of twisting sides 413a in the embodiment is curved.

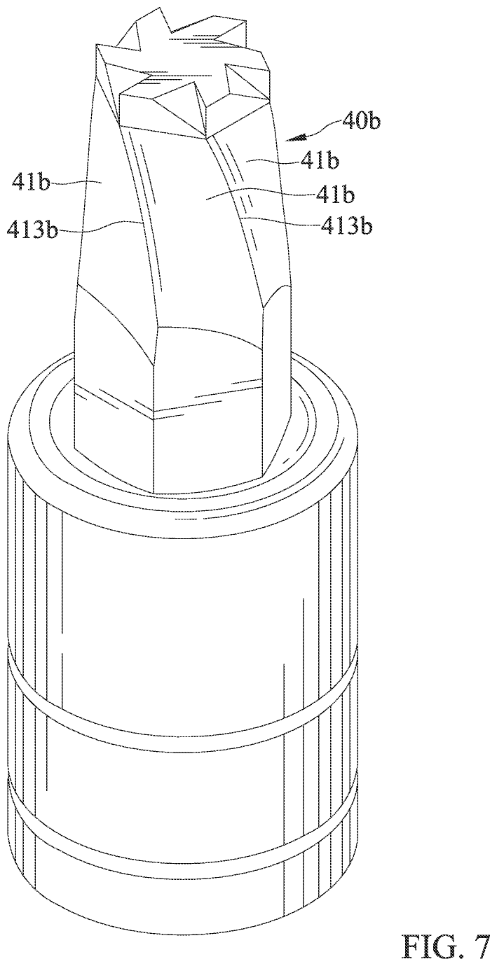

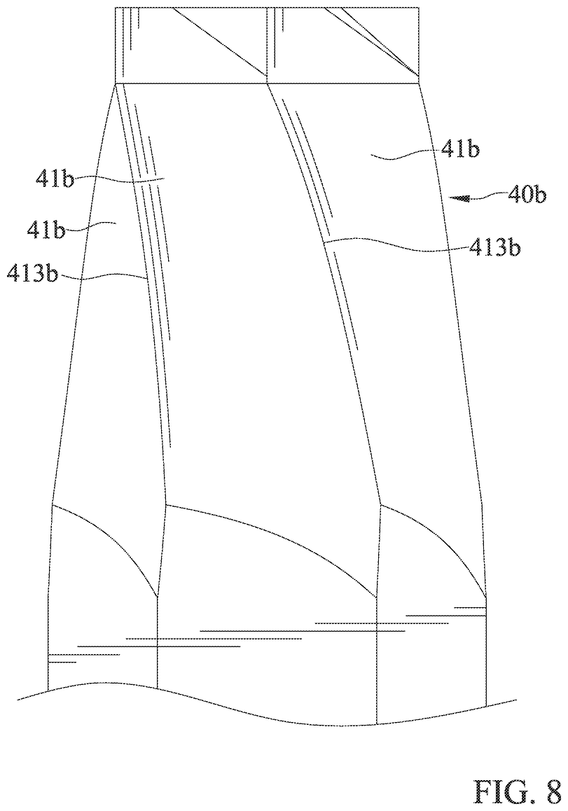

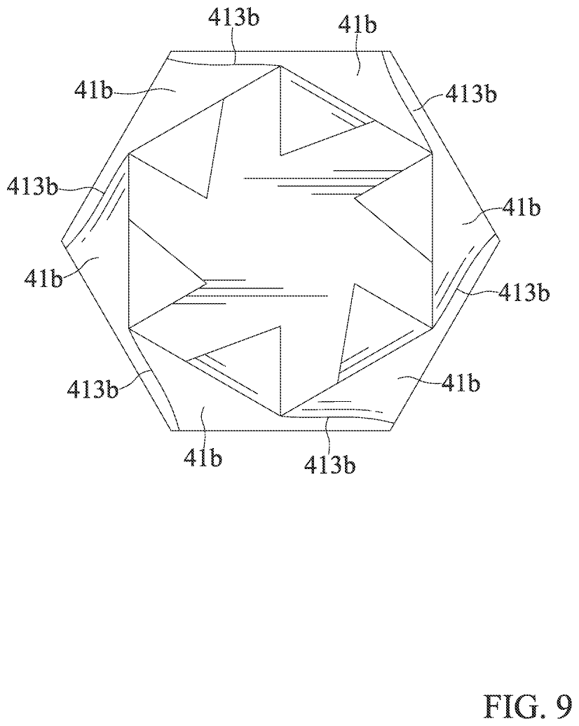

FIGS. 7-9 show a perspective view, a side elevational view, and an end elevational view of an anti-slip fastener driver of a third embodiment according to the present invention. The third embodiment is substantially the same as the first embodiment but is mainly different from the first embodiment by that each of the plurality of the twisting surfaces 41b has a contour using another curved surface function different than that of the first embodiment.

The twisting portion 40b is provided with a plurality of twisting sides 413b each formed between two adjacent of the plurality of twisting surfaces 41b. A number of the plurality of twisting sides 413b is equal to a number of the plurality of twisting surfaces 41b, and each of the plurality of twisting sides 413b in the embodiment is curved.

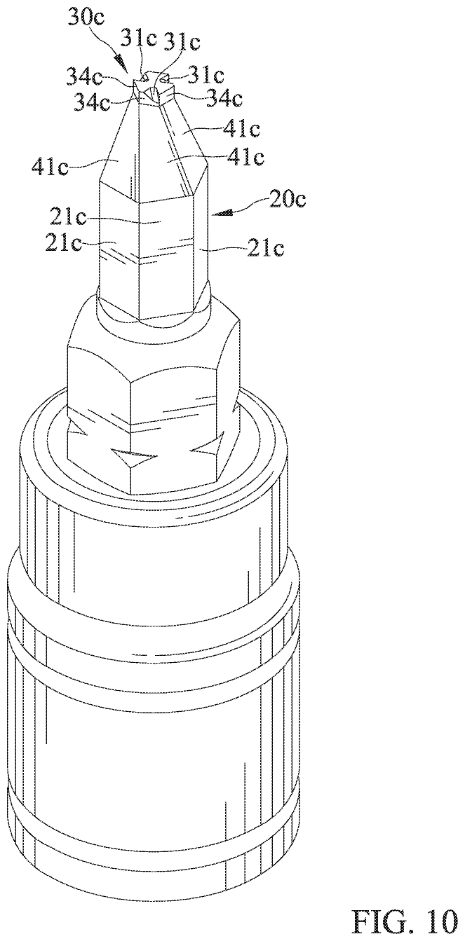

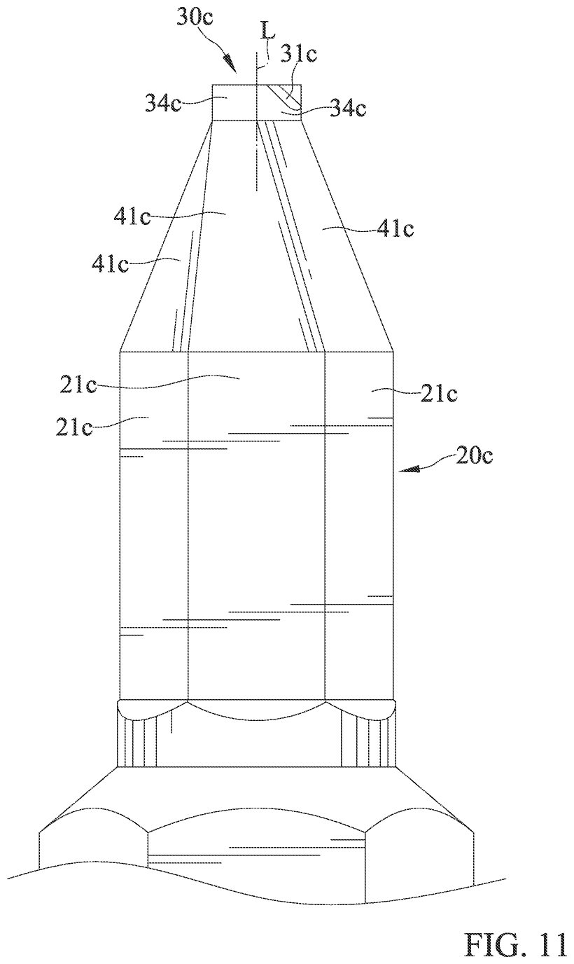

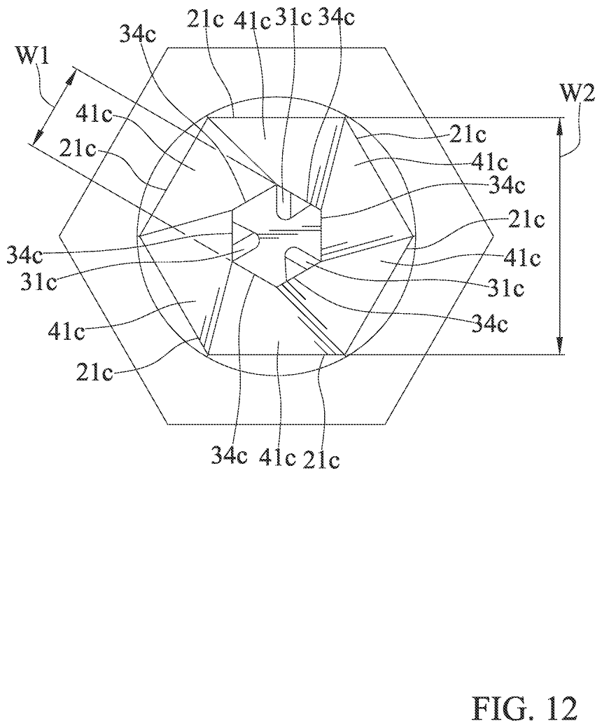

FIGS. 10-12 show a perspective view, a side elevational view, and an end elevational view of an anti-slip fastener driver of a fourth embodiment according to the present invention. The fourth embodiment is substantially the same as the first embodiment but is mainly different from the first embodiment by that an outer periphery of the driving portion 30c in the radial direction of the rotating axis L is provided with six first peripheral surfaces 34c parallel to the rotating axis L. The six first peripheral surfaces 34c are planes and form a hexagon. A first width W1 is formed between two opposite surfaces of the six first peripheral surfaces 34. The plurality of driving recesses 31c includes three driving recesses 31c respectively connected to three non-adjacent of the six first peripheral surfaces 34c. An outer periphery of the body 20 in the radial direction of the rotating axis L is provided with six second peripheral surfaces 21c parallel to the rotating axis L. The plurality of twisting surfaces 41c includes six twisting surfaces 41c each having a top edge connected to the relative first peripheral surface 34c and a bottom edge connected to the relative second peripheral surface 21c. The six second peripheral surfaces 21c are planes and form a hexagon. A second width W2 is formed between two opposite surfaces of the six second peripheral surfaces 21c. The second width W2 is greater than 2.5 times and less than 2.8 times the first width W1.

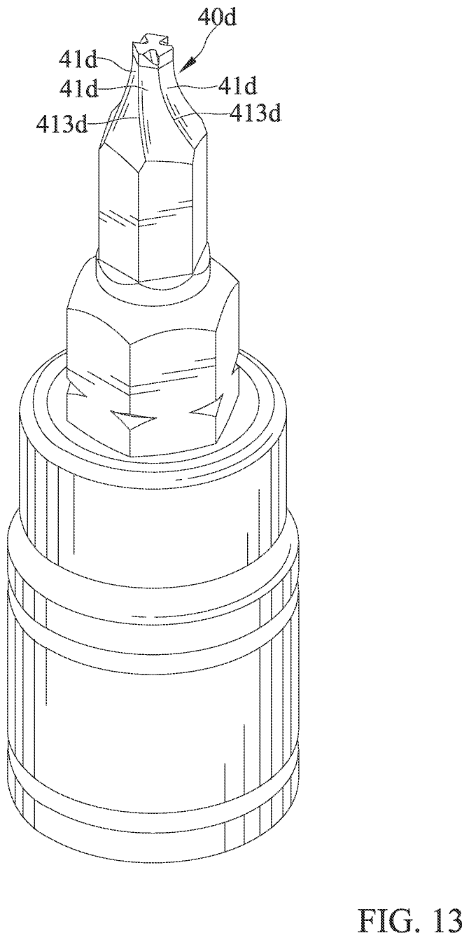

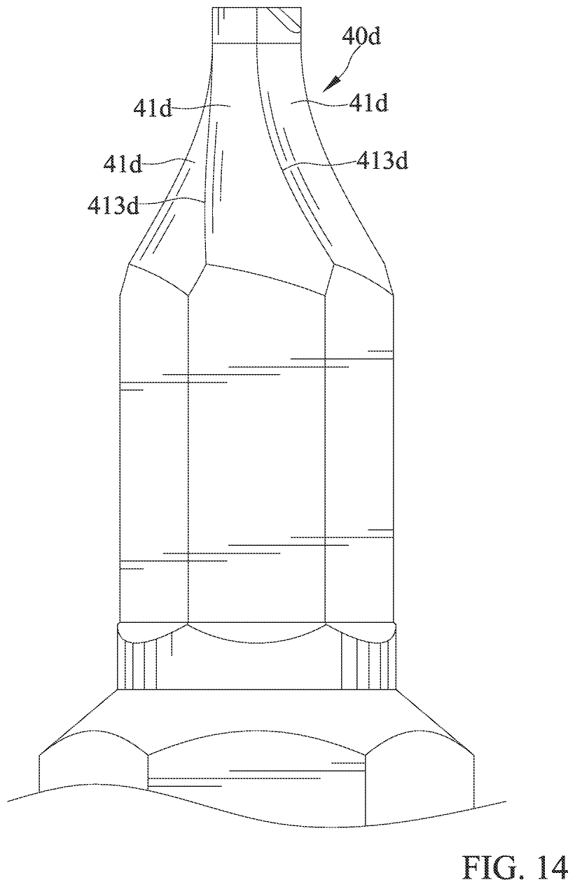

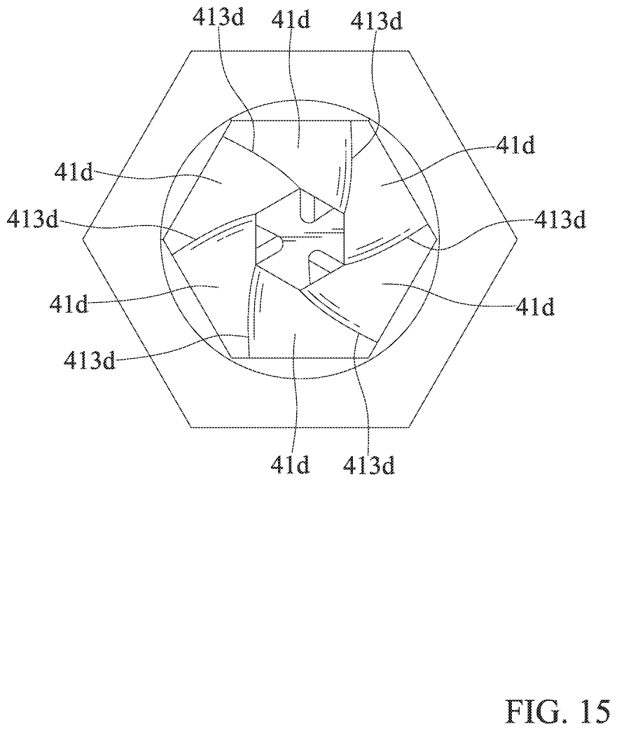

FIGS. 13-15 show a perspective view, a side elevational view, and an end elevational view of an anti-slip fastener driver of a fifth embodiment according to the present invention. The fifth embodiment is substantially the same as the fourth embodiment but is mainly different from the fourth embodiment by that each of the plurality of the twisting surfaces 41d has a contour using another curved surface function different than that of the fourth embodiment.

The twisting portion 40d is provided with a plurality of twisting sides 413d each formed between two adjacent of the plurality of twisting surfaces 41d. A number of the plurality of twisting sides 413d is equal to a number of the plurality of twisting surfaces 41d, and each of the plurality of twisting sides 413d in the embodiment is curved.

Although specific embodiments have been illustrated and described, numerous modifications and variations are still possible without departing from the scope of the invention. The scope of the invention is limited by the accompanying claims.

1. An anti-slip fastener driver comprising:
a body;
a driving portion defining a reference rotating axis and a reference plane perpendicular to the rotating axis, wherein the driving portion has a top end distal to the body in an axial direction of the rotating axis, wherein the top end is provided with a plurality of driving recesses and a plurality of sharp corners respectively adjacent to the plurality of driving recesses; and
a twisting portion defining a first end connected to the driving portion and a second end connected to the body, wherein a cross sectional area of the first end is less than a cross sectional area of the second end in a radial direction of the rotating axis, wherein the twisting portion has a polygonal cross sectional shape in the radial direction of the rotating axis, wherein the twisting portion is provided with a plurality of twisting surfaces formed around an outer periphery thereof about the rotating axis, wherein each of the plurality of twisting surfaces has a short side formed at the first end and a long side formed at the second end, and wherein a projection line of one of the short sides on the reference plane is not parallel to a projection line of one of the long sides corresponding to the short side on the reference plane.

2. The anti-slip fastener driver as claimed in claim 1, wherein each of the plurality of the twisting surfaces has a contour using a curved surface function.

3. The anti-slip fastener driver as claimed in claim 1, wherein the twisting portion is provided with a plurality of twisting sides each formed between two adjacent of the plurality of twisting surfaces, wherein a number of the plurality of twisting sides is equal to a number of the plurality of twisting surfaces, and wherein each of the plurality of twisting sides is straight.

4. The anti-slip fastener driver as claimed in claim 1, wherein the twisting portion is provided with a plurality of twisting sides each formed between two adjacent of the plurality of twisting surfaces, wherein a number of the plurality of twisting sides is equal to a number of the plurality of twisting surfaces, and wherein each of the plurality of twisting sides is curved.

5. The anti-slip fastener driver as claimed in claim 1, wherein the projection line of one of the short sides on the reference plane and the projection line of one of the long sides corresponding to the short side on the reference plane form a twisting angle, and wherein the twisting angle is greater than 20 degrees and less than 40 degrees.

6. The anti-slip fastener driver as claimed in claim 1, wherein the top end of the driving portion has an end surface perpendicular to the rotating axis, wherein the plurality of driving recesses is recessed on the end surface, and wherein the plurality of sharp corners is arranged on an outer peripheral edge of the end surface in the radial direction of the rotating axis.

7. The anti-slip fastener driver as claimed in claim 1, wherein an outer periphery of the driving portion in the radial direction of the rotating axis is provided with six first peripheral surfaces parallel to the rotating axis, wherein the six first peripheral surfaces are planes and form a hexagon, wherein a first width is formed between two opposite surfaces of the six first peripheral surfaces, wherein the plurality of driving recesses includes six driving recesses respectively connected to the six first peripheral surfaces, wherein an outer periphery of the body in the radial direction of the rotating axis is provided with six second peripheral surfaces parallel to the rotating axis, wherein the plurality of twisting surfaces includes six twisting surfaces each having a top edge connected to the relative first peripheral surface and a bottom edge connected to the relative second peripheral surface, wherein the six second peripheral surfaces are planes and form a hexagon, wherein a second width is formed between two opposite surfaces of the six second peripheral surfaces, and wherein the second width is greater than 1.2 times and less than 1.5 times the first width.

8. The anti-slip fastener driver as claimed in claim 1, wherein an outer periphery of the driving portion in the radial direction of the rotating axis is provided with six first peripheral surfaces parallel to the rotating axis, wherein the six first peripheral surfaces are planes and form a hexagon, wherein a first width is formed between two opposite surfaces of the six first peripheral surfaces, wherein the plurality of driving recesses includes three driving recesses respectively connected to three non-adjacent of the six first peripheral surfaces, wherein an outer periphery of the body in the radial direction of the rotating axis is provided with six second peripheral surfaces parallel to the rotating axis, wherein the plurality of twisting surfaces includes six twisting surfaces each having a top edge connected to the relative first peripheral surface and a bottom edge connected to the relative second peripheral surface, wherein the six second peripheral surfaces are planes and form a hexagon, wherein a second width is formed between two opposite surfaces of the six second peripheral surfaces, and wherein the second width is greater than 2.5 times and less than 2.8 times the first width.
